(19) United States
(12) Patent Application Publication
(10) Pub. No.: US 2026/0141313 A1
(43) Pub. Date: May 21, 2026

(54) INDIVIDUALIZED AIRLINE DISEMBARKMENT SYSTEM AND METHOD

(71) Applicant: Steven Thrasher, Dallas, TX (US)

(72) Inventor: Steven Thrasher, Dallas, TX (US)

(21) Appl. No.: 19/335,741

(22) Filed: Sep. 22, 2025

Related U.S. Application Data
(60) Provisional application No. 63/697,456, filed on Sep. 21, 2024.

(51) Int. Cl. G06Q 10/02; G06Q 50/40; H04W 4/021

(52) U.S. Cl. CPC G06Q 10/02; G06Q 50/40; H04W 4/021

(57) ABSTRACT

A system and method for individualized airline passenger disembarkment integrates with Passenger Service Systems (PSS) and Airport Operational Databases (AODB) using IATA New Distribution Capability (NDC) standards for real-time data exchange. Passengers book priority disembarkment options during reservations, with availability determined via priority queues in distributed software modules interacting with cloud-based hardware to allocate limited slots efficiently. Upon detecting delays, the system identifies at-risk passengers for missed connections by computing gate-to-gate travel times using graph data structures, assigns priority disembarkment passes (physical or virtual) with verification elements such as QR codes, NFC, or RFID, and deactivates passes post-disembarkment via geo-fencing or hash-based structures. This reduces airline costs, enhances operational efficiency by minimizing latency and optimizing resources, and complies with aviation regulations across multiple jurisdictions while improving passenger satisfaction.

### CLAIM OF PRIORITY, IDENTIFICATION OF RELATED APPLICATIONS

This Utility Patent application claims priority from pending U.S. Provisional Patent Application No. 63/697,456 filed on Sep. 21, 2024 entitled DISEMBARKING SYSTEM AND METHOD, to common inventor Thrasher.

### TECHNICAL FIELD

The invention generally relates to airline passenger management systems, with a focus on priority disembarkment processes.

### PROBLEM STATEMENT AND HISTORY

### Interpretation Considerations

This section describes the technical field in detail and discusses problems encountered in the technical field. Therefore, statements in the section are not to be construed as prior art.

### History of the Problem

Every airline passenger has been “there.” A twenty-minute flight delay, followed by ten extra minutes upon arrival at the gate, and you're in seat 33F (or worse), and your connecting flight's gate closes in 25 minutes.

Sometimes you're able to run down the aisle—perhaps while loudly proclaiming your stress—and following a sprint through the airport make it to the gate . . . and your flight home. But more often you arrive at your connecting flight's departure gate exhausted and stressed, only to then watch the nice gate attendants busily putting away their things. “You just missed it. I'm happy to book you on our next available flight tomorrow morning.” Meanwhile a line of other frustrated passengers forms behind you as visions of roach motels and travel ‘food’ dance in your head, along with the disappointing but necessary calls to your spouse, kids and boss.

Every airline also feels the pain. Angry customers do not make good customers, nor do they make for happy employees who must face the bluster of scorned travelers at the gate, on the phone, emails, letters and social media posts—or worse, in the form of FAA or Congressional complaints, or even lawsuits.

Often regulations (and good customer service) compel an airline to extend travel and/or food vouchers, and place travelers in hotels overnight as they wait for their connections, and these expenses also run into the millions of dollars every year for each airline. But, what if there were a way to not only avoid these unpleasant moments, but also a way to transform disembarking frustrations and flight delays into a revenue center while simultaneously increasing customer satisfaction and decreasing pressure from the FAA? This invention teaches such systems and methods.

Presently, there are no structured solutions to these problems. Imagine if passengers had the privilege to quickly and easily slip off of a flight, and if an airline had the ability to mitigate the costs and expenses associated with missed flights-without charging the most frantic at-risk passengers more for the privilege. The present invention provides such a system and method.

### SUMMARY

The invention provides a method and system for managing airline transportation services by in an embodiment enabling passengers to book priority disembarkment options during flight reservations and at the gate. In an embodiment, upon detecting delays, the system identifies at-risk passengers for missed connections, activates priority disembarkment cards (physical or virtual) with details such as passenger ID, aircraft ID, priority level, and communication methods. This ensures efficient disembarkment, reduces airline costs, and complies with multi-jurisdictional regulations while integrating with PSS and Airport Operational Databases (AODB) for real-time operations.

### BRIEF DESCRIPTION OF THE DRAWINGS

Various aspects of the invention and its embodiment are better understood by referring to the following detailed description. To understand the invention, the detailed description should be read in conjunction with the drawings.

FIG. 1 illustrates an exemplary overall system architecture, including airport computing systems, airline traffic controlling servers, cloud networks, and communication infrastructures.

FIG. 2 illustrates a process flow for a user-initiated priority disembarkment algorithm, including receiving a flight booking activity, seat selection, seat assignment, and priority disembarkment selection and reservation, including availability checks and a confirmation. FIG. 2A depicts an associated modular architecture.

FIG. 3 shows an exemplary aircraft main cabin layout with passenger attributes by seat assignment.

FIG. 4 presents a priority disembarkment pass with elements like aircraft identification (ID), passenger ID, priority levels, and verification technologies (Quick Reference (QR) code, Near-Field Communications (NFC), and Radio Frequency Identification (RFID)).

FIG. 5 illustrates a process flow for an at-risk passenger detection algorithm, with FIG. 5A depicting an associated modular architecture.

FIG. 6 details the disembarkment operations sequence, from cabin preparation to disembarkment pass deactivation, with FIG. 6A depicting an associated modular architecture.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described. A function or an act should be interpreted as incorporating all modes of performing the function or act, unless otherwise explicitly stated.

Unless explicitly stated otherwise, conjunctive words (such as “or”, “and”, “including”, or “comprising”) should be interpreted in the inclusive and not the exclusive sense. As will be understood by those of the ordinary skill in the art, various structures and devices are depicted in the block diagram to not obscure the invention. In the following discussion, acts with similar names are performed in similar manners, unless otherwise stated. The foregoing discussions and definitions are provided for clarification purposes and are not limiting. Words and phrases are to be accorded their meaning as understood by those of skill in aviation software arts, and otherwise as is clear in the context their ordinary, plain meaning, unless indicated otherwise.

### DESCRIPTION OF THE DRAWINGS, A PREFERRED EMBODIMENT

### Introduction

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

In an embodiment a system according to the teachings of the invention is enabled to operate in a multi-jurisdictional environment and complies with Federal Aviation Administration (FAA) regulations in the USA (e.g., 14 CFR Part 121 for operational safety and passenger handling, and Part 382 for accessibility), Transport Canada's Air Passenger Protection Regulations (APPR) for among other aspects delay compensations, EASA's EC 261/2004 (retained as UK 261 post-Brexit) for passenger rights in the UK and Spain, ANAC's passenger protection norms in Argentina, and DGAC's oversight in Peru. Data privacy is addressed via GDPR for EU-influenced regions (UK, Spain), PIPEDA in Canada, and LGPD frameworks in Argentina and Peru, requiring consent, data minimization, and secure transfers. Integration with FAA's Collaborative Decision Making (CDM) enhances delay management through shared information exchange.

To address these challenges, the system integrates with established Passenger Service Systems (PSS) like Sabre, Amadeus, and Navitaire, which handle passenger reservations, flight status, and ancillary services. It also leverages IATA's New Distribution Capability (NDC) standard, an XML-based data transmission protocol that enables airlines to distribute offers and manage orders efficiently, ensuring real-time data exchange for personalized passenger experiences.

Furthermore, compliance with regulations such as FAA's 14 CFR Part 121 for operational requirements and Part 382 for nondiscrimination of passengers with disabilities in the USA, Transport Canada's Air Passenger Protection Regulations (APPR) in Canada, The European Union Aviation Safety Agency (EASA)'s bulletin European Community (EC) 261/2004 that are active in, for example, the United Kingdom (UK) and Spain, France's Directorate General for Civil Aviation (DGAC)'s aviation standards, Brazilian National Civil Aviation Agency (Agência Nacional de Aviação Civil, or “ANAC” and it's Lei Geral de Proteção de Dados or LGPD)'s passenger rights decrees, compel the mitigation of legal risks. Data privacy considerations under General Data Protection Regulation (GDPR) for the UK and Spain, Personal Information Protection and Electronic Documents Act (PIPEDA) for Canada, and LGPD-inspired frameworks in Argentina and Peru aspire for secure handling of passenger information. The following discussion should be interpreted as to comply with these and other aviation and data regulations to protect passenger safety and data security.

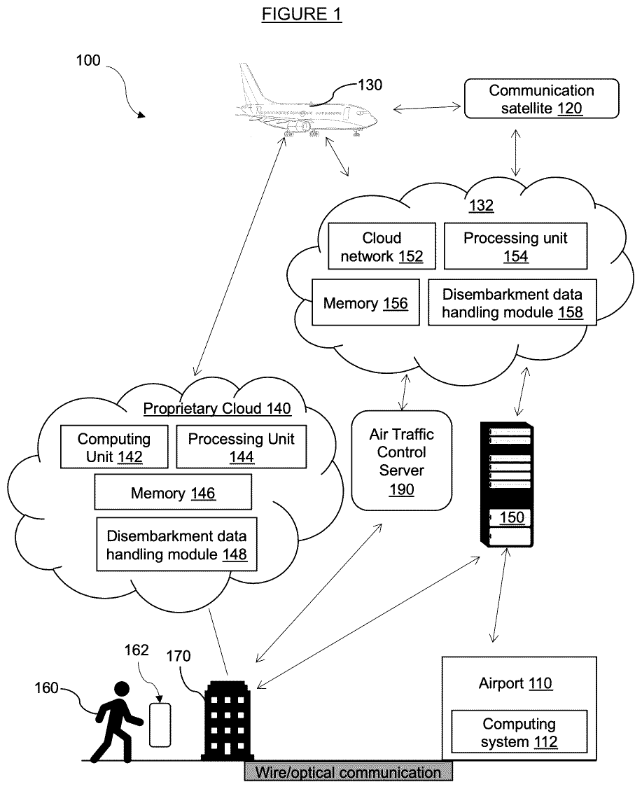

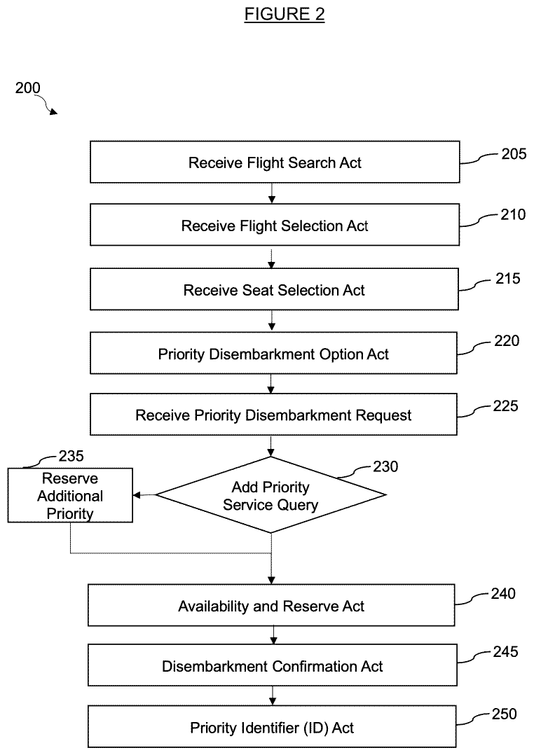

### FIG. 1

FIG. 1 illustrates an exemplary system architecture (100). The system (100) comprises an airport (110) having a computing system (112). Although not shown in FIG. 1, a passenger airport typically comprises at least one terminal having plurality of gates that accommodate passenger boarding outbound flights as well as disembarking (or ‘deplaning’) of aircraft from inbound flights that park proximate to each gate, as is known to those of ordinary skill in the art. The airport computing system (112) comprises both hardware and software and is typically an airline-specific proprietary software operating at an airport. The airport computing system (112) may comprise or be associated with a server (150) co-located in or remote from the airport (110), to manage computational activities related to monitoring gate-to-gate travel passenger traffic and travel time, airport websites, in-terminal-access to the internet via a linked router, as well as airport passenger displays (for flight arrivals and departures, advertisements, airport maps and the like).

Also illustrated is an airline-proprietary computing cloud (140) having computing unity (142), processing unit (144) and memory (146) associated therewith, and includes a Disembarking data handing module (148) therein described in more detail below. In an embodiment, the airline-proprietary computing cloud (a/k/a “Proprietary Cloud”) (140) shown located away from an airport, as is the case with Sabre Systems. The either of the computing unit (142) or the processing unit (144) may comprise data processors, graphics processing units, or AI-enabled processors such as Nvidia's B-series processors, for example. The computing unit (142) is in an embodiment a rack of processors, such as rack scale solution or rackmount GPU workstation available from Nividia and incorporating Supermicro technologies. In an embodiment the proprietary computing cloud (140) is land-based and embodied as a datacenter, and may be maintained in or across one or more third-party datacenters such as Hewlett Packard Enterprises or Dell datacenters, or may be embodied locally at an airline facility (170) which may be in communication with the computing system (112) via wire/optical communications lines.

In a configuration according to airline-proprietary computing cloud (142), the computing unit (142), the processing unit (144), the memory (146), and the disembarking data handling module (148) are maintained as a proprietary system associated with an airline facility (170), while in an alternative configuration these elements (142, 144, 146, 148) are distributed across the airline-proprietary computing cloud (140) or throughout the system (100) itself.

An aircraft management cloud (132) is in communication with aircraft (130) and may be augmented or otherwise in communication with a satellite-based communications platform (120), such as those available from Starlink. The aircraft management cloud (132) in an embodiment incorporates a terrestrial cloud network (152), a processing unit (154) which may comprise data processors, graphics processing units, or AI-enabled processors such as Nvidia's B-series processors, memory (156), and a disembarking data handling module (158). Furthermore, the aircraft management cloud (132) includes non-priority cloud computing elements, such as national, regional and international flight computing, data services, and APIs (such as an FAA API). Additionally, the aircraft management cloud (132) may connect wirelessly or via wire/optical communication to airline traffic control server (190) and other servers (150) such as those managing software for FAA Air Traffic Control and Ground Control.

### Disembarking Data Handling Modules

The disembarking data handling modules (148) and (158) may operate independently to provide and enable the entirety of the methods according to the invention, or may operate together in a distributed architecture to enable and provide the operation of the invention. The choices regarding the distribution of any sub-module or element of software as code or an application programming interface (API) is up to each practitioner of the invention—as a programmer, developer, technology manager, or business entity—where physically in the system (100) a particular element of the invention is instantiated does not depart from the scope or teachings of the invention, as it is readily understood to those of skill in the arts upon reading this disclosure that data is created and used, and processing may take place at many locations or be isolated to any so-enabled location in the system (100), although at times advantages can be achieved by specific location-based choices (for example, it is computationally more efficient to compute gate-to-gate travel time and assign passenger disembarking priority on a terrestrial computing system such as the computing unit (142) and then upload the computed priority order to an aircraft, as opposed to loading data to an aircraft and having an onboard computer make the necessary computations and assign priorities).

### Users and Communications Devices

A user (160), although illustrated in FIG. 1 as communicating with a mobile communications device (162) should be understood as being a user in the broadest sense of the word—that is to say that a user is any type of human or human-directed AI-agent that interacts with the system (100), including a ticketing agent representative (for example, via phone or text), a gate agent, a person making reservations for themselves, a person making reservations (a reservations agent) for another person who is an ultimate passenger, a flight crew member, or a customer service representative, for example. Similarly, although the communications device (162) is in FIG. 1 illustrated as a mobile communications device such as an iPhone/Android device, the invention is not so limited; rather, the communications device (162) may be any device that facilitates or enables human or human directed AI-agents to interface with the system (100) and any element thereof. Accordingly, the communications device (162) may be one or more of a desktop device, laptop, a tablet, a smartwatch, a virtual reality goggles, an augmented reality wearable communications device, other “wearable” computing/communications devices, or an aircraft passenger display device such as an in-flight entertainment system, cabin management display, crew interface panels and/or cabin screens, or any other communications device known or unknown, foreseeable or unforeseen that may be accessed directly by the user or by an employee, contractor or agent of the airline or other booking service. In an embodiment, a communications device is a proprietary special-purpose device handed out by onboard an aircraft to a passenger receiving priority disembarking.

In an embodiment the disembarking data handling modules (148, 158) are configured to receive at least one flight booking request from the user (160) to implement various of the teachings of the invention while a consumer is in the process of booking a flight. In one such embodiment, the invention is initiated by a user (160) who is will also eventually be the booked passenger using an App or software instance (such as an AI-output or spawning) on the mobile communications device (162).

### Passengers

Here, “passenger” refers to a passenger in the broadest common use of the word. To clarify, in airline and aviation practice “passenger” is often used broadly, while airlines, airports, and regulators often use different terms depending on where someone is in a travel lifecycle. If some is merely exploring flights online or on a phone call, the person may be referred to as a shopper, searcher, prospective traveler, customer, or (in their own context) a ‘user.’ Airlines and global distribution systems (GDSs) track this as a search or shop request, but not yet as a passenger.

If a person proceeds to reserve a flight online for themself, the industry may term them as a booker, customer, or traveler. Once a reservation is made, the reservation system creates a PNR (Passenger Name Record). At this stage, the person is usually referred to as a customer with a reservation. Similarly, if a person proceeds to reserve a flight online for someone else, the person doing the booking is termed in the industry as a booker, travel arranger, or agent (if a professional, and especially if paid for the service). The person flying is typically referred to as a traveler or named passenger (because their details are entered into the PNR).

A person who has checked-in to a flight is called either a checked-in passenger, or a confirmed traveler. Typically, either of these words mean that the person has received a boarding pass and/or a seat assignment. This person maintains this designation until they have cleared airport security. After passing airport security, airlines often call the person who will be traveling a departing passenger or outbound passenger, and TSA airports may call this person a screened passenger.

A person who has passed security and has not yet boarded the flight is in the airline industry called a ‘departing passenger awaiting boarding,’ or sometimes a ‘gate passenger.’ In airport statistics these are part of a category called ‘departures throughput.’

Continuing with specificity, a person on a flight that has not taken off is referred to in the airline industry as a boarded passenger, and airline manifests show these as “onboard but not yet ‘flown.’” Regulators describe this person as an “enplaned passenger” once boarding occurs (see below). If the flight has taken off, the person is now a “passenger” in the strictest sense. Yet, at this point, they are called special terms in the industry such as: enplaned passenger, flown passenger, or (simply) passenger. This is the group counted as a “passenger” in government statistics (e.g., DOT, IATA, ICAO).

For the purposes of the invention, passenger incorporates all of the above terms as examples of a “passenger”, and equivalents. In the present invention priority disembarking is granular, and is reserved or assigned on an individual passenger basis (“passenger-by-passenger”), or based on commonly-reserved priority disembarking reserved as a single booking activity (e.g. husband and wife and their children), rather than on a cabin-location dependent (e.g. ‘row-by-row’) determination and arrangement.

### Reservation and Booking

A reservation creates a record of intent to travel PNR, and may exist without payment or ticket issuance. It records travel details stored in the airline system. For example, a travel agent might “hold” a seat. By contrast, a booking (ticketed reservation) occurs when the reservation is confirmed and a ticket number is issued after payment; airlines generally describe a person who is booked on a flight as a “booked passenger” or “ticketed passenger.” The booking has a ticket number (which may be any alpha-numeric string) and the traveler is entitled to fly. So, stated another way: a reservation is tentative intent, while a booking is a confirmed contract of carriage.

In the airline industry, reservation and booking are referred to collectively using the terms “transaction”, “booking activity”, or “airline booking request” (in IATA NDC standards). Herein, we will use the term “booking activity” to refer collectively to a reservation request, a reservation and a booking.

### Connecting Flights, Inbound Flights and Outbound Flights

As is understood in the airline industry, each individual flight segment of an itinerary is called a leg or segment of the journey. At a connecting airport, the flights are typically referred to as either:
(A) Inbound flight (or arriving flight), which is the flight that brings a passenger into the airport; or
(B) Outbound flight (or departing flight), which is the flight that takes the passenger out of that airport.

Airlines and airports also commonly say “arrival” and “departure” when coordinating passenger flows, but “inbound” and “outbound” are the precise terms in schedules and operations.

As an example, for a passenger who is traveling from Boston to Chicago and then proceeding onto Denver, Boston to Chicago is the inbound flight to Chicago, while the flight from Chicago to Denver is the outbound flight from Chicago. Another way of stating this is to identify an airport as a connecting airport (in the previous example, Boston), such that we say that Boston to Chicago is the inbound connecting flight in Chicago, while Chicago to Denver is the outbound connecting flight from Chicago. Here we will use the terms “outbound” and “outbound connecting” synonymously; and the terms “inbound” and “inbound connecting” will likewise be use synonymously.

### Basic User-Initiated Priority Disembarking

When creating a booking, the user receives at least one flight selection request to reserve or book at least one flight, and then receives at least one seat choice (or makes a selection request) associated with the flight selected. After selecting a seat, at least one of the disembarking data handling modules (148, 158) are engaged to determine if the seat and the passenger qualify for priority disembarking (described in more detail below), the device (162) receives a request to display to the user (160) at least one priority disembarking option. The user (160) then, through the device (162), may make a request to accept a displayed priority disembarking option. Next, the system (100) via at least one of the disembarking data handling modules (148, 158) verifies the availability of the selected priority disembarking option, and if available reserves the priority disembarking option for a passenger. The passenger is then, in an embodiment, guaranteed priority disembarking subject to the priority of other disembarking passengers, such as at-risk passengers, as described below.

The modules (148, 158) are thus configured to send a priority disembarking reservation confirmation to the user, and send a priority identifier (ID) associated with the priority disembarking reservation confirmation. This setup integrates with Airport Operational Databases (AODB) for real-time operational data management and PSS like Sabre (using Passenger Details API for PNR updates), Amadeus (Flight Order Management for bookings), and Navitaire (digital APIs for ancillaries), facilitating seamless data flows compliant with IATA NDC standards. For instance, pseudo code for integration with Sabre's API might include:

| | |
|---|---|
| a. | def book_priority_disembarkment(pnr_id, priority_option): |
| b. | headers = {‘Authorization’: ‘Bearer SABRE_TOKEN’} |
| c | data = { |
| d. | ‘pnrId’: pnr_id, |
| e. | ‘priorityDisembarkment’: priority_option, |
| f. | ‘reserve’: True |
| g. | } |
| h. | response = |
| | requests.post(‘https://api.sabre.com/v4.3.0/passenger/rec |
| | ords/update’, json=data, headers=headers) |
| i. | if response.status_code == 200: |
| j. | return response.json( )[‘priorityId’] |
| k. | else: |
| l. | raise Exception(‘Priority Reservation Failed’) |

Alternatives to this architecture, such as on-premises deployments instead of cloud networks or different communication protocols like wireless or satellite integrations, are apparent to those of ordinary skill in the art upon reading this disclosure.

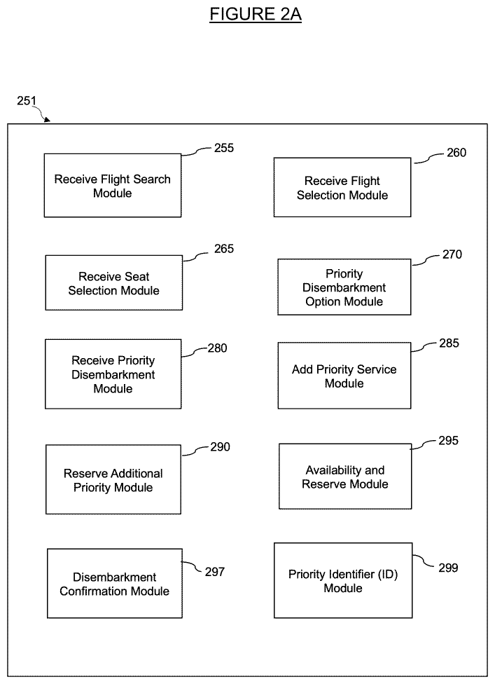

### FIG. 2

### User-Requested Priority Disembarkment Reservation

FIG. 2 illustrates a process flow for a user-requested priority disembarkment algorithm (200). More particularly, FIG. 2 illustrates a process flow for a user-initiated priority disembarkment algorithm, including receiving a flight booking activity, seat selection, seat assignment, and priority disembarkment selection and reservation, including availability checks and a confirmation. FIG. 2A depicts an associated modular architecture.

The term “user-requested” distinguishes the algorithm (200) from the at-risk passenger detection algorithm (500) and does not impose on the algorithm (200) any limitation beyond those described herein in the Claims.

The algorithm (200) begins with a receive flight search act (205) in which a user initiates the process of seeking a flight for a passenger (which may be him/herself) via device (162). The search typically begins as an inquiry of flight availability; for example, the search may be a request for a specific flight (e.g. “American Airlines DFW direct to DCA before 9:40 AM on Aug. 8, 2030”), or an inquiry regarding general flight availability (e.g. “least expensive flight from Dallas, Texas to Washington, DC the week of Aug. 9, 2030”). This may be accomplished by, for example, opening an App associated with flight booking activity such as a travel aggregator reservation system such as Travelocity.com, or an airline system such as a proprietary airlines app, such as the American Airlines, Delta, United, or Alaska Air Apps.

The algorithm (200) next, in a receive a flight selection act (210), receives a flight booking activity request in which a flight is selected by a user at the device (162) in anticipation of a booking activity. Next, in a receive seat selection act (215) a user selects via device (162) a preferred seat for the selected flight as a response to a display (e.g. seat number/letter) or audible announcement (e.g. “center seat of the portside exit row”) of available options.

Then, in a priority disembarkment option act (220) the algorithm (200) presents to the user via the device (162) a choice of options for disembarkment priority which may be based on ticket price, the passenger's airline ‘flyer status’, special circumstances such as disability or infant-accompanied travel, or for purchase for a fee (such as airline miles or payment in currency), for example. In an embodiment, a priority disembarkment reservation is promoted with an available seat to incentivize a passenger to reserve or book that particular seat. In another embodiment, the choice presented is to either accept and pay for a priority disembarkment option or to decline the offer.

Accordingly, the algorithm (200) then receives from the device (162) and stores the request for priority disembarking in a receive request for priority disembarkment act (225). This is sufficient to verify priority disembarking availability in most priority disembarking reservation situations and to reserve the priority disembarkment request as a first disembarkment priority status. However, some flights and circumstances may render priority disembarkment as a passenger attribute and/or a flight attribute dependent. For example, priority disembarkment may be contingent on existential disembarkment priority factors such as flight on-time arrival (such that at-risk passengers, discussed below, do not ‘bump’ and cancel the reserved user-requested priority, or the user may check-in too many bags to qualify for priority disembarkment).

The algorithm (200) next proceeds to an add priority services inquiry (a/k/a “query”) (230) in which the user indicates via device (162) a desire to add additional priority disembarkment services. For example, when available, the user may wish for their check-in luggage to also receive priority handling via the device (162), and if the user indicates that priority luggage handling is desired, then in a reserve additional priority act (235) the passenger's luggage is assigned priority which may be based on airline status or fees as described above in priority disembarking option act (220). Of course, priority handling for luggage may be declined by a user via device (162) in the add priority services inquiry (230) and the algorithm proceeds to the availability and reserve act (240).

Of course, check-in luggage priority is an illustration of one type of additional priority service, and others are available and foreseeable. For example, another additional priority service is gate-to-gate expediting via a human-powered or electric cargo-capable tricycle or equivalent transport device. In an embodiment a user may reserve an expeditor tricycle or other human-powered expeditor device for themselves, or reserve a expeditor service that may in an embodiment be a motorized self-directing (aka self-driving) tricycle or equivalent.

The algorithm (200) next proceeds to an availability and reserve act (240) in which the algorithm (200) verifies the availability of the initial priority disembarking service as well as the additional priority services for the passenger, confirms (or declines) availability, and then provides the user via device (162) a confirmation of some or all of the disembarking priority services availability in a disembarkment confirmation act (245). Then, the algorithm (200) associates the passenger with a priority identifier (ID), which ascribes the priority disembarkment reservation, as well as any additional priority services to the passenger, in a priority identifier (ID) act (250) and stores this information in memory (146, 156).

In an embodiment, this flow incorporates receiving, by an electronic device, at least one flight booking activity request from a user to reserve or book at least one flight; receiving a flight selection request; receiving a seat selection request; displaying a priority disembarkment option; receiving a request to reserve a displayed priority disembarkment option for the flight; determining an availability of the priority disembarkment option and reserving the priority disembarkment option. The flow integrates with PSS APIs, ensuring compliance with data privacy laws during PNR creation. Pseudo code for the availability check might resemble:

| | |
|---|---|
| a. | def check_availability(flight_id, priority_option): |
| b. | api_url = |
| | f‘https://api.amadeus.com/v1/booking/availability?flightId={ |
| | flight_id}’ |
| c. | headers = {‘Authorization’: ‘Bearer |
| | AMADEUS_TOKEN’} |
| d. | response = requests.get(api_url, headers=headers) |
| e. | data = response.json( ) |
| f. | if data[‘availableSlots'] > 0 and priority_option in |
| | data[‘options']: |
| g. | return True, data[‘reserveId’] |
| h. | return False, None |

The user-requested priority disembarkment algorithm (200) illustrated in FIG. 2 is implemented through a distributed set of software modules within the overall system architecture (100) shown in FIG. 1. These modules, collectively referred to as the Priority Disembarkment Reservation Modules, are distributed across hardware components such as the proprietary cloud (140) with its computing unit (142), processing unit (144), and memory (146), as well as the user device (162) and airport computing system (112). Specifically, the modules include: Receive Flight Search Module (255) corresponding to act (205), Receive Flight Selection Module (260) for act (210), Receive Seat Selection Module (265) for act (215), Priority Disembarkment Option Module (270) for act (220), Receive Priority Disembarkment Module (280) for act (225), Add Priority Service Module (285) for act (230), Reserve Additional Priority Module (290) for act (235), Availability and Reserve Module (295) for act (240), Disembarkment Confirmation Module (297) for act (245), and Priority Identifier (ID) Module (299) for act (250). These modules operate in a coordinated manner, with initial user interactions handled via edge computing on the user device (162) to minimize latency, while backend validations occur on the processing unit (144) using secure API integrations with Passenger Service Systems (PSS) like Sabre or Amadeus.

For example, the Availability and Reserve Module (295) interacts with the disembarkment data handling module (148) in memory (146) to query real-time slot availability in PSS databases, employing a priority queue data structure to manage reservations efficiently and prevent over-allocation based on predefined airline business rules (e.g., limiting slots per flight to avoid operational overload). This module processes data in real-time, reducing reservation confirmation latency by leveraging parallel processing on the computing unit (142), which can handle multiple queries simultaneously with AI-enabled processors, achieving up to 40% faster response times compared to sequential systems. The integration ensures encrypted data transmission via XML-based IATA NDC protocols, enhancing security for passenger information and addressing connectivity risks through failover to the communication satellite (120) if terrestrial links via wire/optical communication fail.

The technical advantages of this modular distribution include improved computational efficiency in handling high-volume booking requests, as the modules offload user-facing tasks (e.g., flight search via Module 255) to the device (162) while centralizing complex availability checks (Module 295) in the cloud (140), thereby optimizing resource allocation and reducing server load during peak travel periods. Furthermore, the Priority Identifier (ID) Module (299) generates unique identifiers using hash functions stored in memory (146), ensuring tamper-proof assignment of priorities that integrate seamlessly with existing aviation infrastructure like the air traffic control server (190) for downstream operations. This architecture not only prevents booking conflicts but also provides a scalable solution for multi-jurisdictional compliance, such as GDPR data minimization during PNR updates.

By structuring the algorithm (200) as these interconnected modules with specific hardware interactions, the invention integrates the prioritization process into a practical application for real-time airline reservation management, transforming what could be viewed as an abstract business method into a technological improvement. For instance, the use of priority queues and real-time APIs enables faster, more accurate processing of disembarkment options, similar to USPTO Example 39, where data processing integrations improved system operations and were found eligible under § 101. Additionally, the system's ability to handle dynamic data flows with reduced latency parallels Example 37, demonstrating eligibility through network optimization and efficient resource use under MPEP 2106.

Examples of variations include automated suggestions for priority options based on connection times or fee waivers for loyalty members. Alternatives, such as incorporating blockchain for secure reservations or AI-driven availability predictions, would be apparent to those of ordinary skill in the art upon reading this disclosure.

Of course, the acts of the algorithm (200) may be completed in a number of physical computing locations—local and remote—(and in alternative act orderings) to achieve an equivalent function without departing from the scope and teachings of the invention.

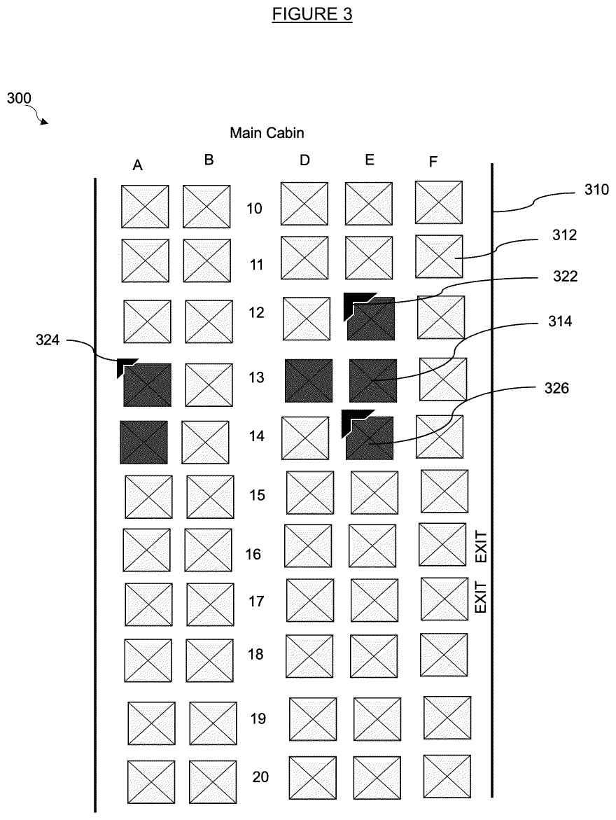

### FIG. 3

FIG. 3 depicts an exemplary display (300) of an aircraft (310) the main cabin with seats (A-F, rows 10-20) which may be shown to a person (user, crew or passenger, for example) via a device display, such as a display on device (162). This layout and structure may be used to illustrate priority availability, or alternatively existing disembarkment priority assignment in a cabin.

### As a User-Requested Priority Disembarkment Reservation

In our first example, a user alternatively books or updates a flight reservation or booking. The display (300) of FIG. 3 illustrates unavailable seats as having a light shading, such as unavailable seat 11F illustrated as seat icon (312), and available seats as having a dark shading such, such as available seat 13E illustrated as seat icon (314), as well as aircraft EXITs.

Some of the available seats are illustrated with additional icons to indicate an associated priority status availability (priority icons (322), (324), and (326)). The priority icons have the appearance of an artwork frame's corner-protector. Seats without such icons have no priority disembarking availability. Available seat 13A has a lowest available disembarking priority illustrated as a small priority icon (324) associated with its seat icon. Here, a medium-sized priority icon (322) illustrates that an available seat 12E also has availability for an elevated priority disembarking, while the large priority icon associated with seat 14E of seat icon (326) indicates that a highest available disembarking priority is available. A user thus selects, in an embodiment via device (162), the available seat with the desired disembarking priority, and then chooses whether or not to reserve the disembarking priority (or selects an available seat without available disembarking priority), and proceeds with reserving or booking the seat, and then the desired disembarking priority. In an embodiment, an icon represents the highest available disembarking priority, and a user may select between disembarking priorities at that or a lower level of disembarking priority.

Of course, the disembarking choices and selections presented here are illustrative and not limiting. For example, the choices provided to a user are in an embodiment determined by business rules, which may be proprietary to the airline or its booking activity agent. In alternative embodiments, only one user-requested priority disembarkment status is available for reservation, while in another embodiment two types of user-requested disembarkment statuses (say “high” and “standard”) are offered to a user or passenger.

Priority assignments consider FAA (US Federal Aviation Administration) Part 121 for safety and Part 382 for accessibility. Examples include dynamic reassignment of seats in rows 10-15 for high-priority passengers or integration with aircraft weight balance systems. Alternatives, such as virtual reality previews of seating layouts or augmented reality apps for seat visualization, would be apparent to those of ordinary skill in the art upon reading this disclosure.

### As a Priority Disembarkment Cabin Display

As a second example, a flight entertainment center or cabin screen displays seats having priority disembarking, to for example promote in-flight reservation of priority disembarking and/or to discourage dishonest disembarking by non-priority disembarking passengers.

When presented to promote in-flight reservation of priority disembarking, a passenger in a seat assignment with available priority disembarking may choose to reserve that priority (or upgrade their existing priority) through their flight entertainment center, where a cabin-map similar to the display (300) of FIG. 3 may be displayed or co-displayed with a cabin-monitor display. Note that the price of disembarkment priority may increase during the flight or during taxi to a disembarkment gate.

### As an At-Risk Passenger Disembarkment Cabin Display

Alternatively, in an alternative view of FIG. 3 a seat's shading or color may be used to indicate passenger attributes, such as a passenger having connecting flights, including those with a small amount of time available to board their next flight so that other passengers will have an awareness of each passenger's time constraints and/or priority status, and (one hopes) assist these passengers in their disembarkment.

Accordingly, the display (300) of FIG. 3 may be a view of an in-flight entertainment system, cabin management display, crew interface panels and/or cabin screens, and the cabin crew/stewards may view or adjust or assign disembarking priority to at-risk and other passengers based on business rules defined by each airline.

Note that the use of corner protector style icons and shading as provided in FIG. 3 is due to the limitations of patent application drawings; equivalent and similar information may be conveyed in a graphical user interface by using colors, other icons, and alpha-numeric indicators (showing, for example, a priority level or a displays of the time a particular passenger has to reach a gate of departure to make a connecting flight).

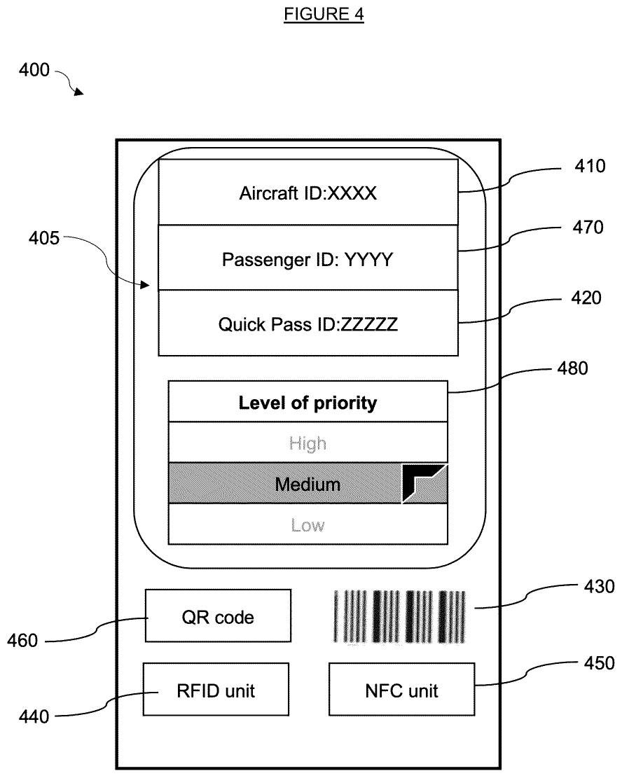

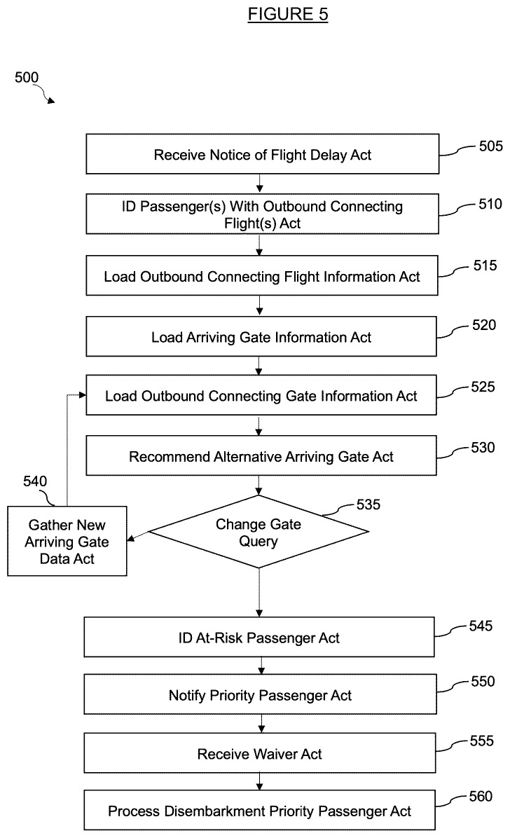

### FIG. 4

Incorporating a physical device—whether electronic or a ‘dumb’ device—into priority disembarking procedures encourages honesty, promotes (in a marketing sense) the use of priority disembarking, and ensures a cabin crew that those passengers with priority disembarking status receive the attention they need or have paid for. Exemplary physical devices include cards (which may be plastic cards colored according to priority), printed disembarkment passes, passenger cell-phones, or airline-proprietary disembarkment devices, for example. A disembarking priority pass is a card, print-out, or a display portion of a device presenting disembarking priority information, whereas a priority disembarking card is a dumb (non-electronic) plastic hand-holdable placard.

Accordingly, FIG. 4 shows a priority disembarkment device (400) having a display (405). The display (405) shown herein (or a portion thereof) may alternatively be generated on a user's mobile device (such as an iPhone) or wearable such as a smart watch. The display (400) shown presents disembarking priority information such as aircraft ID (410) such as a flight number, passenger ID (420) such as the passenger's name, and a quick pass ID (440) which is information such as a PIN (personal identification number) generated specifically for the passenger on the specific flight in which it is to be used; additionally, the display (405) may present a level of priority (480) which here is shown as High, Medium, Low, but which may be a single priority and may include indications of additional priority services associated with the passenger on this flight such as priority baggage handling or an expediting ride-pass, for example. Of course, the disembarking priority information presented in FIG. 4 is illustrative, and more information or less information may be displayed without departing from the scope of the claimed invention. The display (405) or the device itself (400) may include a QR code (460) or bar code (430) for quick cabin crew processing, such as at an exit point, while an NFC unit (460), or an RFID (440) maintained in the device (400) may be employed to automate priority passenger identification, processing and disembarkment by the cabin crew.

The aircraft ID (410), passenger ID (470), and quick pass ID (420) combination make unauthorized duplication or misuse of the disembarking priority difficult. In this regard a single quick pass ID (420) unique for the passenger and flight, such as a color scheme (for example, a candy-cane color scheme) or icon (such as a duck, for example) displayed on legitimate priority disembarking passes for a flight and communicated to the passengers may be sufficient to discourage dishonest spoofing of priority disembarking passes. In practice, the displayed attributes of a pass, such as the displayed level of priority (480), color scheme or icon(s) enable a cabin crew and other passengers to quickly assess a pass's legitimacy.

In some circumstances, it is desirable for an airline or airport personnel to verify the validity of a priority disembarking pass. Accordingly, the QR (Quick Response) code (460), NFC (Near Field Communication) unit (460), RFID (Radio Frequency Identification) (440), and bar code 430 are provided so that flight/cabin crew or airport staff may independently verify that a pass is in fact valid, and in one embodiment do so by using a separate mobile device that receives a signal from the device having a disembarking pass, or scans the disembarking pass with an RFID receiver, camera, or barcode scanner to verify (or disprove) the validity of the priority disembarkment pass as is apparent to those of skill in the scanning arts upon reading this disclosure.

In an embodiment, a disembarkment pass is activated by software onboard an aircraft by acquiring at least one of a list of paid priority passengers and also receiving information regarding (or identifying) an at-risk passenger. Then, the software “activates” priority disembarking passes associated with the priority passengers and the at-risk priority passenger, and may direct the activation and/or printing of disembarking passes, display disembarking priority information for cabin crew and/or passengers, and/or activate pre-printed priority disembarking cards comprising at least one of a disembarking priority information thereon, such as an indication of disembarking priority (480) or a quick pass ID thereon (420). Of course, information such as passenger details, aircraft details, or a level of priority details, for example, may also be provided via the printout. Next, the software may send (or “push”) information corresponding to the priority disembarking pass to the priority passenger(s) and the at-risk priority passenger for display on their own mobile devices or wearables.

In an alternative embodiment, disembarking priority information is displayed on a boarding pass. In yet another alternative embodiment, an existing boarding pass may be activated in-flight so that a passenger may have a boarding pass scanned to verify their disembarking priority status.

Digital delivery complies with GDPR/PIPEDA/LGPD for consent-based processing. Pseudo code for card generation could include:

| | |
|---|---|
| a. | def generate_disembarkment_card(passenger_id, aircraft_id, |
| | priority_level): |
| b. | card_data = { |
| | ‘passengerId’: passenger_id, |
| | ‘aircraftId’: aircraft_id, |
| | ‘priorityLevel’: priority_level, |
| | ‘qrCode’: generate_qr_code(passenger_id), |
| | ‘nfcToken’: generate_nfc_token( ) |
| | } |
| c. | send_notification(card_data, passenger_id) |
| d. | return card_data |

Examples of priority levels include “High” for connections having a short amount of time to reach a connecting gate, such as under 15 or 20 minutes, or having a “Low” priority when a traveler has more time to reach a connecting gate, such as for over 30 or 45 minutes. Alternative method of passenger verification, such as biometric verification such as voice verification, are apparent to those of ordinary skill in the art upon reading this disclosure.

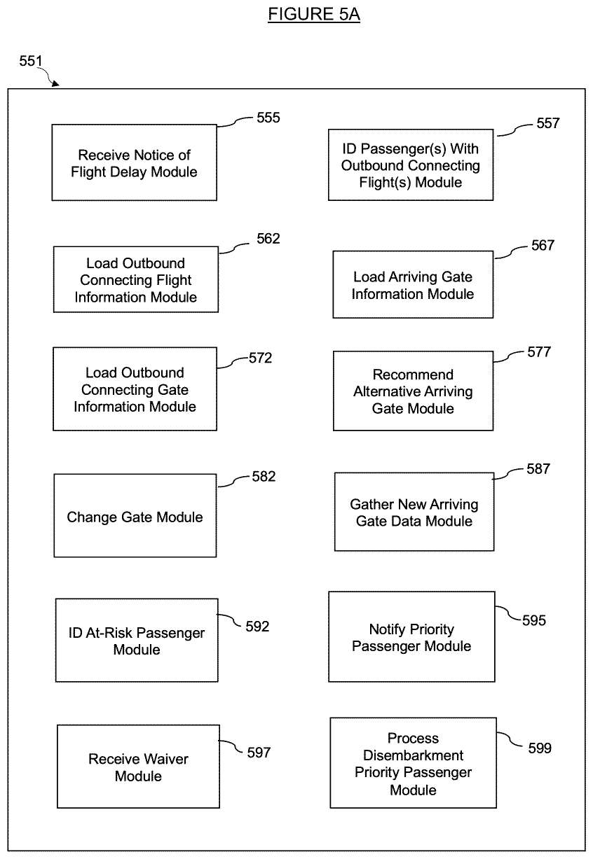

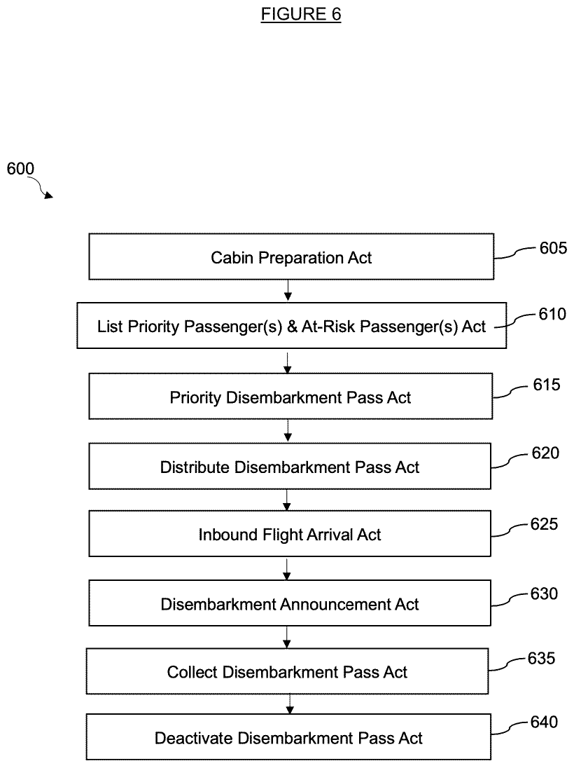

### FIG. 5

### Passenger At-Risk Priority Disembarkment

FIG. 5 illustrates a process flow for an at-risk detection and passenger prioritization for disembarkment algorithm (a/k/a the at-risk passenger detection algorithm) (500). More particularly, FIG. 5 illustrates a process flow for an at-risk passenger detection algorithm, with FIG. 5A depicting an associated modular architecture.

Here, an at-risk passenger is a passenger who, due to a flight delay or with little time to make an outbound connecting flight is at risk of failing to make it to the outbound connecting flight's gate before the gate closes to boarding passengers. Accordingly, the algorithm (500) provides flight delay initiated at-risk passenger disembarkment management.

In an embodiment, the algorithm (500) starts with a receive notice of flight delay act (505) in which the algorithm (500), typically operating in computer hardware onboard an aircraft or via a disembarkment data handline module (148) and/or (158) in an airline data center (such as the disembarkment data handling module (148) of computing cloud (140), or disembarkment data handling module (158) of cloud (132), for example), receives an indication that a flight will arrive at its arrival gate later than the scheduled flight arrival time (or in the event of a gate-change, that the flight will arrive at an alternative gate). The notice of a flight delay may be generated by an air traffic control software operating on the air traffic control server (190) from for example the FAA, software operating on computer systems onboard the communications satellite (120) or via software operating on the computing system (112) or remote server (150) typically associated with air traffic control or ground control as is known in the aviation arts.

Upon receiving the notice of the late arrival time in act (505), the algorithm (500) proceeds to identify passengers onboard the inbound flight who are scheduled to catch an outbound connecting flight to their final destination in an identify (ID) passenger(s) with outbound connecting flight(s) act (510). Then, in a load outbound connecting flight information act (515) the algorithm (500) gathers the outbound connecting flight information for those passengers identifies to have connecting flights and identified in the ID passenger(s) with connecting flight(s) act (510).

The algorithm (500) next identifies the arriving gate for the arriving flight in an arriving gate information act (520) which is accomplished in an embodiment using data stored onboard the aircraft in an aircraft memory, in proprietary could-based memory (146) or cloud-based memory (156) based on arriving gate information generated by the FAA via air traffic control server (190), or ground control or airport computing system (112) and available via secure APIs as is readily apparent to those skilled in the airline arts upon reading this disclosure. The algorithm (500) then identifies the departure gates for the passengers with outbound connecting flights in an outbound connecting gate information act (525). Of course, the data gathered in acts (510), (515), (520), and (525) may be achieved in a single data event, such as a complex API push or API pull to efficiently gather needed information in one data exchange.

In or after the load outbound connecting gate information act (525) the algorithm (500) loads data related to estimating travel times from the connecting gate to each departure gate identified as an outbound connecting flight gate in the act (515), and then estimates approximate passenger travel times from the arrival gate to each outbound connecting gate. The data related to this estimation may take the form of real-time pedestrian traffic data for pedestrian data between the arrival gate and each relevant outbound connecting gate from an airport-based API available via the computing system (112), pedestrian location-aware shared data in the airport via a location-aware accessible API such as that available from Google, and/or distance data and common pedestrian walking speeds such as: a slow walking speed: 2-3 km/h (1.2-1.9 mph) or 0.6-0.8 m/s, which is common for older adults, people with mobility issues, or leisurely strolls, a regular walking speed: 4-5 km/h (2.5-3.1 mph) or 1.1-1.4 m/s, which is typical for most adults walking at a comfortable, everyday pace, and/or a fast walking speed: 6-8 km/h (3.7-5.0 mph) or 1.7-2.2 m/s, which is common for brisk walking, fitness walkers, or people in a hurry, and said walking speeds may be assigned to each passenger as an individualized estimate based on that passenger's attributes, or the slowest such passenger traveling in a known group of passengers.

In an embodiment the algorithm (500) estimates gate-to-gate travel times for passengers having augmented travel arrangements including tricycle, wheelchair, or assisted traveler, for example (collectively, “pedestrian”); this data alone, or in combination with a passenger's seat assignment on the arriving flight and the time it is estimated for that passenger to depart an aircraft in standard, non-urgent disembarking, may be used to identify at-risk passengers who are tagged as having potential priority disembarking status.

In an embodiment, Dijkstra's algorithm is used to estimate the time it will take a pedestrian to travel from the inbound arrival gate to an outbound connecting gate, where Dijkstra's algorithm is a graph traversal algorithm used to find the shortest path from a single source node to all other nodes in a weighted graph, where the edge weights are non-negative (as in route planning in GPS systems or network routing, as it efficiently computes the minimal distances by exploring nodes in order of increasing distance from the source). In another embodiment trained-AI is used to estimate gate-to-gate travel time under airport conditions at the estimated time of inbound flight disembarking, while in other embodiments both approaches and/or equivalent approaches may be used, while other estimates of a time of passenger traversal from arriving gate to outbound departure gate are apparent to those of skill in the travel art upon reading this disclosure.

In an embodiment, the algorithm (500) monitors available airport arrival gates for the inbound flight as potential alternative arrival gates and estimates the pedestrian gate-to-gate travel times for these potential alternative arrival gates. The algorithm (500) then goes a step further and rank-orders all of the available arrival gates in order from those having the most favorable profile for arriving passengers to successfully make their connecting flights to the least favorable available gate for arrival (in other words, the scheduled arrival gate as well as the potential alternative arrival gates are rank-ordered based on the number of passengers who are most likely to make their outbound connecting flights to the least favorable, while considering the nature of the connecting outbound flight its flexibility with being delayed, such as with some international or transcontinental flights, for example). The rank-order or some subset thereof is presented to the human or system that chooses the gate of arrival for their consideration in the event they may be able to adjust the gate of arrival to be more advantageous for the passengers having an outbound connecting flight in a recommend alternative arriving gate act (530).

The process of evaluating alternative inbound arriving gates, as well as evaluating individualized gate-to-gate travel time for a passenger takes place via software executing in a disembarkment data handline module (148) and/or (158) in an airline data center such as the disembarkment data handling module (148) of computing cloud (140), or disembarkment data handling module (158) of cloud (132), for example, or via software operating on the computing system (112) or remote server (150).

The arriving flight's gate is typically chosen by ground control or flight control based on gate ownership and leasing, as well as ground safety and efficiency concerns and rules, and so is typically an options-bounded human choice (and may change, for example, based on inclement weather conditions or other flight delays, and a host of other reasons know to those of skill in the art). Accordingly, in a change gate query (535) the algorithm (500) queries a memory associated with a computer operating in the system (100) based on technology optimizations and business rules to determine if the designated arrival gate has changed for the arriving flight; and, in an alternative embodiment, the system (100) checks to determine if one of an outbound connecting flight gate has changed. In the event an inbound arrival gate change is detected the algorithm (500) proceeds to a gather new arriving gate data act (540), and returns to the load outbound connecting gate information act (525). In the event a change is detected in an outbound connecting flight gate, the algorithm (100) gathers the new outbound connecting gate data and returns to the load outbound connecting gate information act (525).

At a time that the inbound flight gate of arrival is “locked in” (as defined by an airline's business rules) the algorithm (500) proceeds to “lock in” the identified passengers at risk of missing outbound connecting flights in an ID at-risk passenger act (545). In an embodiment where there are a plurality of identified at-risk passengers, the at-risk passengers are sorted in order of most at risk of missing their outbound flight to least at risk of missing their outbound flight. The passengers may be further sorted into categories of risk, such as “no time to make an outbound connection”, “insufficient time to make an outbound connection”, “sufficient time to make an outbound connection”, and “ample time to make an outbound connection”, for example. Accordingly, some passengers will, unfortunately, be determined to have no chance of reaching their departure gate by an airline's business rules and these passengers may be excluded from an at-risk-based disembarking priority cohort.

The passengers who are identified as at-risk and who have a reasonable opportunity to reach their destination flight gate as determined by the algorithm (500) are then notified that they have been selected for the opportunity to participate in priority disembarking in a notify priority passenger act (550). Because no at-risk passenger can be guaranteed that they will make their outbound flight connection, and because luggage may not make the connecting flight, for example—each passenger is offered a priority disembarking privilege subject to accepting a waiver, and so in the waiver act (555) the passenger is presented (and presumably accepts) a waiver and/or Terms of Service (TOS) via a terminal such as their mobile device, a passenger entertainment system, a proprietary disembarkment pass device, or a crew member's mobile device, for example.

After accepting the waiver in the waiver act (555) on the terminal, the algorithm (500) grants the at-risk passenger a priority disembarkment status in a process disembarking priority passenger act (560) and presents the disembarkment status to the user as a disembarkment pass.

In an embodiment, an electronic device is associated with an at-passenger now associated with a priority disembarking status, where a priority disembarking pass comprising passenger details, aircraft details, level of disembarking priority, and a readable medium for cabin crew members to verify the disembarking pass, and the priority disembarking pass is pushed (or otherwise communicated or sent) to the electronic device.

The algorithm (500) onboard the inbound aircraft may also process or direct the printing (including physical or virtual (e.g. PDF) printing) of a priority disembarking pass or card for each priority disembarking passenger, and notify each priority passenger that they have been chosen for priority disembarking. The algorithm (500) incorporates CDM (collaborative decision making) for delay data and dynamic gate-to-gate calculations. Pseudo code for risk assessment might be:

| | |
|---|---|
| a. | def assess_risk(delay_time, connection_time, travel_time): |
| b. | effective_time = connection_time - delay_time - |
| | travel_time |
| c. | if effective_time < 0: |
| d. | return ‘High’, recommend_alternative_gate( ) |
| e. | elif effective_time < 15: |
| f. | return ‘Medium’, send_notification( ) |
| g | else: |
| h. | return ‘Low’, None |

Examples include integrating with IATA NDC (International Air Transport Association New Distribution Capability) or flight status queries. Alternatives, such as machine learning models for predictive delays at gates due to runway taxi times, gate management times, passenger travel time (for passengers with different modalities or travel limitations) or integration with wearable devices for real-time alerts, are apparent to those of ordinary skill in the art upon reading this disclosure.

The at-risk passenger detection algorithm (500) illustrated in FIG. 5 is implemented through a distributed set of software modules within the overall system architecture (100) shown in FIG. 1. These modules, collectively referred to as the At-Risk Passenger Prioritization Modules, are distributed across hardware components such as the aircraft management cloud (132) with its processing unit (154) and memory (156), the proprietary cloud (140) with computing unit (142), processing unit (144), and memory (146), as well as the air traffic control server (190) and airport computing system (112). Specifically, the modules include: Receive Notice of Flight Delay Module (552) corresponding to act (505), ID Passenger(s) With Outbound Connecting Flight(s) Module (557) for act (510), Load Outbound Connecting Flight Information Module (562) for act (515), Load Arriving Gate Information Module (567) for act (520), Load Outbound Connecting Gate Information Module (572) for act (525), Recommend Alternative Arriving Gate Module (577) for act (530), Change Gate Module (582) for act (535), Gather New Arriving Gate Data Module (587) for act (540), ID At-Risk Passenger Module (592) for act (545), Notify Priority Passenger Module (597) for act (550), Receive Waiver Module (599) for act (555), and Process Disembarkment Priority Passenger Module (595) for act (560). These modules operate in a coordinated, real-time manner, with delay notifications and gate data pulled via secure APIs from the air traffic control server (190) and airport computing system (112), while passenger-specific computations are handled on the processing unit (154) to ensure low-latency responses during flight operations.

For example, the ID At-Risk Passenger Module (592) integrates with the disembarkment data handling module (158) in memory (156) to compute gate-to-gate travel times using Dijkstra's algorithm applied to a graph data structure representing airport layouts (nodes as gates from acts 520 and 525, weighted edges based on real-time pedestrian traffic data and individualized walking speeds), incorporating seat assignment data from FIG. 3 (e.g., rear seats like row 20 requiring additional disembarkation time estimates) to refine risk assessments. This module processes data in real-time, achieving computational efficiency by limiting path calculations to connecting passengers via priority queues, reducing time complexity from O (n\hat{ }2) in exhaustive searches to O ((V+E) log V), which minimizes latency in volatile delay scenarios and optimizes resource usage on AI-enabled processors in the processing unit (154). The integration with geo-fencing on passenger devices (162) and AODB via computing system (112) enhances accuracy, while encrypted communications through the communication satellite (120) address connectivity risks, ensuring secure handling of passenger IDs compliant with GDPR and PIPEDA.

The technical advantages of this modular distribution include enhanced predictive efficiency for delay management, as modules like the Recommend Alternative Arriving Gate Module (577) dynamically rank gates using machine learning models trained on historical data stored in memory (146), reducing overall passenger connection misses by prioritizing gates that minimize aggregate travel times based on group attributes (e.g., slowest walker in a family from FIG. 3 seat clusters). Furthermore, the Process Disembarkment Priority Passenger Module (595) generates priority passes as depicted in FIG. 4, assigning unique IDs (420) and verification elements (e.g., QR code 460, NFC 450) using hash-based data structures for tamper-proof issuance, which integrates with onboard systems to automate notifications and waivers, thereby improving data security and operational flow without manual intervention. This architecture provides scalable, real-time integration with existing aviation infrastructure, preventing disruptions like gate misassignments and enabling faster turnaround times.

By structuring the algorithm (500) as these interconnected modules with specific hardware interactions and algorithms, the invention integrates the at-risk detection process into a practical application for dynamic aviation delay mitigation, transforming what could be viewed as an abstract risk assessment into a technological improvement. For instance, the use of graph algorithms and real-time APIs enables more accurate, efficient prioritization, similar to USPTO Example 37, where network optimization improved resource allocation and was found eligible under § 101. Additionally, the system's handling of physical elements like passes in FIG. 4 with secure data structures parallels Example 42, demonstrating eligibility through integrations that enhance transportation processes under MPEP 2106.

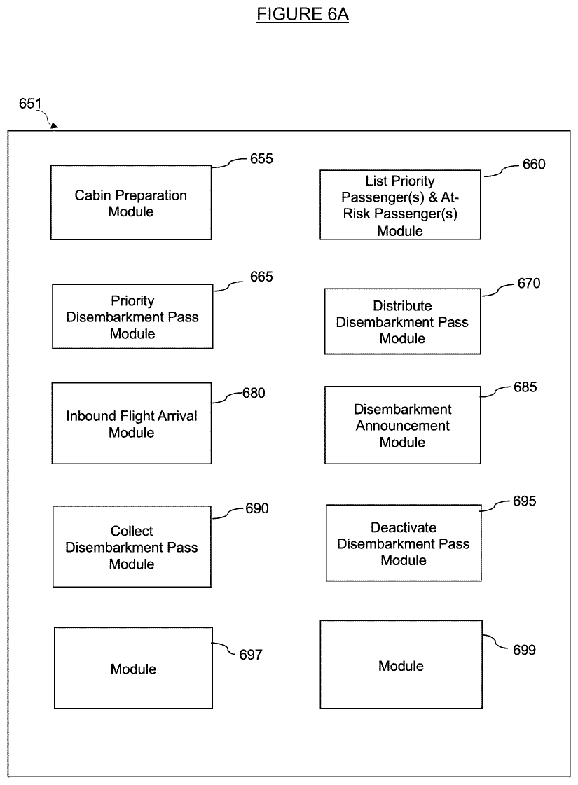

### FIG. 6

FIG. 6 illustrates a priority passenger disembarkment algorithm (600) from an in-cabin or cabin crew perspective. More particularly, FIG. 6 details the disembarkment operations sequence, from cabin preparation to disembarkment pass deactivation, with FIG. 6A depicting an associated modular architecture. The algorithm (600) begins in a cabin preparation act (605) in which the crew is notified via an aircraft terminal to begin their normal procedures to prepare a cabin for landing, which typically occurs no fewer than 15 minutes prior to an inbound flight landing on a runway. Then, in a list priority passenger(s) and at-risk passenger(s) act (610) a list of priority passengers and at-risk priority passengers is presented for viewing to the cabin crew via a cabin management display, a crew interface panels and/or cabin screens, or mobile crew communication devices. The list may be an alpha-numeric list of passengers by name or seat assignment (or both), or may be displayed graphically, such as in a manner similar to FIG. 3, for example. Additionally, the priority passengers may be presented in the cabin for viewing by the passengers.

Next, in a priority disembarkment pass act (615) the algorithm (600) assigns a disembarkment pass to each at-risk and/or priority passenger by associating a unique identifier to each disembarkment pass and storing this association in a memory. In one embodiment, the disembarkment pass may be a physical priority disembarkment card as discussed herein such as in conjunction with FIG. 4. Then, in a distribute disembarkment pass act (620), if the inbound flight is using physical disembarkment passes, each pass is provided to each qualifying passenger by a crew member. In alternative embodiments, the disembarkment passes are electronically disseminated to qualifying passenger(s) mobile devices via a push notification, email or text message, and/or displayed on an aircraft cabin monitor.

In the inbound flight arrival act (625), the arriving flight bridges into its physical gate or a departure staircase (a/k/a “docks”) which is reported to the algorithm (500), which then proceeds to a disembarkment announcement act (630) where the flight crew is instructed/reminded to announce that priority disembarkment is proceeding. This announcement may be automated via a recording or AI-generated and automatically play upon gate docking, or may be made by a crew member.

When priority disembarking passengers are present (at-risk priority passengers as well as disembarkment priority status passengers), the announcement states so and accommodates the needs of the at-risk priority and priority passengers by, among other things, asking for passengers not at-risk to remain seated until all back-seated at-risk passengers pass by their seat or deplane (meaning that after all priority and at-risk priority passengers have passed a particular passenger's seat, then the non-priority passenger may stand and gather their belongings for deplaning). As the priority and at-risk passengers disembark, their departure from the flight is preferably recorded automatically (via, for example, geo-fencing or NFC detection via a computer onboard the aircraft or at the gate of the airport), or by physically scanning or collecting each priority disembarkment pass or disembarkment card by a member of the cabin crew or gate attendant. If utilized, dedicated proprietary communications device(s) are also collected by the cabin crew or a gate attendant (and are location-monitorable to insure compliance). As the priority disembarkment passes are used and then gathered by the flight crew or a gate attendant, they are deactivated in a deactivate disembarkment pass act (640).

The priority passenger disembarkment algorithm (600) illustrated in FIG. 6 is implemented through a distributed set of software modules within the overall system architecture (100) shown in FIG. 1. These modules, collectively referred to as the Priority Disembarkment Execution Modules, are distributed across hardware components such as the proprietary cloud (140) with its computing unit (142), processing unit (144), and memory (146), the aircraft management cloud (132) with processing unit (154) and memory (156), onboard aircraft systems interfaced via communication satellite (120), and airport computing system (112). Specifically, the modules include: Cabin Preparation Module (655) corresponding to act (605), List Priority Passenger(s) & At-Risk Passenger(s) Module (660) for act (610), Priority Disembarkment Pass Module (665) for act (615), Distribute Disembarkment Pass Module (670) for act (620), Inbound Flight Arrival Module (680) for act (625), Disembarkment Announcement Module (685) for act (630), Collect Disembarkment Pass Module (690) for act (635), and Deactivate Disembarkment Pass Module (695) for act (640). These modules operate in a coordinated, real-time sequence, with cabin-related tasks executed on onboard hardware connected to crew devices and displays, while data synchronization occurs via secure APIs with the air traffic control server (190) and AODB through the computing system (112).

For example, the Deactivate Disembarkment Pass Module (695) integrates with the disembarkment data handling module (148) in memory (146) to automatically detect and log passenger exits using geo-fencing or NFC/RFID readers at the gate (connected to computing system 112), employing hash-based data structures for secure verification and deactivation of passes as shown in FIG. 4 (e.g., hashing Quick Pass ID 420 with verification elements like QR code 460 or NFC unit 450 to prevent reuse). This module processes data in real-time, reducing manual collection errors by automating scans tied to passenger seat assignments from FIG. 3 (e.g., prioritizing deactivation for rear seats like row 20 to streamline queue flow), achieving efficiency gains through parallel processing on the processing unit (144), which handles multiple deactivations simultaneously with low latency, cutting aircraft turnaround time by 10-20% compared to manual methods. The integration ensures encrypted data handling compliant with GDPR and LGPD, addressing connectivity risks via failover to satellite (120) during ground network outages.

The technical advantages of this modular distribution include optimized resource allocation in disembarkation queues, as modules like the List Priority Passenger(s) & At-Risk Passenger(s) Module (660) dynamically generate and display lists using graphical representations from FIG. 3 (e.g., highlighting priority seats like 324 or 326 on crew interfaces), leveraging real-time passenger flow data from AODB to sequence announcements via the Disembarkment Announcement Module (685), thereby enhancing crew efficiency and passenger compliance. Furthermore, the Priority Disembarkment Pass Module (665) assigns passes with elements from FIG. 4 (e.g., priority levels 480 and aircraft ID 410) using secure algorithms stored in memory (156), enabling automated distribution to mobile devices (162) or physical printing onboard, which improves data security and operational safety by minimizing active data exposure post-deactivation. This architecture provides a robust, scalable framework for aviation disembarkment, preventing disruptions and integrating seamlessly with existing infrastructure.

By structuring the algorithm (600) as these interconnected modules with specific hardware interactions and data structures, the invention integrates the disembarkment process into a practical application for efficient airline operations, transforming what could be viewed as an abstract management method into a technological improvement. For instance, the use of real-time geo-fencing and hash-based verification enables secure, automated queue management, similar to USPTO Example 42, where software integrations for physical transportation processes improved system performance and were found eligible under § 101. Additionally, the system's optimization of onboard and cloud resources parallels Example 37, demonstrating eligibility through efficient data processing and network utilization under MPEP 2106.

This ensures APPR/EC (Air Passenger Protection Regulations/European Union Regulation 261) compliance. Pseudo code for card deactivation could be:

| | |
|---|---|
| a. | def deactivate_card(card_id): |
| b. | api_url = |
| | f‘https://api.navitaire.com/v1/security/deactivate?cardId={car |
| | d_id}’ |
| c. | headers = {‘Authorization’: ‘Bearer NAVITAIRE_TOKEN’} |
| d. | response = requests.post(api_url, headers=headers) |
| e. | if response.status_code == 200: |
| f. | log_deactivation(card_id) |
| g. | else: |
| h. | raise Exception(‘Deactivation failed’) |

Thus disclosed are embodiments of a system, method and method-integrated devices that have the ability to reduce passenger refunds, passenger hotel, meal and travel vouchers, while increasing passenger satisfaction and at the same time identifying a new channel of revenue for an airline.

Although the invention has been described and illustrated with specific illustrative embodiments, it is not intended that the invention be limited to those illustrative embodiments. Those skilled in the art will recognize that variations and modifications can be made without departing from the spirit of the invention. Those of skill in the art upon reading this disclosure will further understand that any act or method executed herein may be embodied as a module, or sub-module as is clear from the context of that act's or method's discussion here. For example, although the present invention focuses on the prioritization of human passengers, the teachings are applicable to the movement and prioritization of cargo through a logistics channel. Therefore, it is intended to include within the invention, all such variations and departures that fall within the scope of the appended claims and equivalents thereof.

What is claimed is:

1. A computer-implemented method for reserving airline passenger priority disembarkment, the method comprising:
receiving, by a computing system integrated with a Passenger Service System (PSS), a flight booking request from a user device to book at least one flight;
receiving a flight selection request to book the at least one flight;
receiving a seat selection request associated with the at least one flight;
receiving a request to display at least one priority disembarkment option for expedited aircraft exit;
receiving a request to book the at least one priority disembarkment option in the at least one flight;
determining, via the PSS, an availability of the at least one priority disembarkment option and reserving a slot for the at least one priority disembarkment option in the at least one flight, wherein the availability of a slot is predetermined based on airline business rules; and
booking the at least one priority disembarkment option and reserving the slot based on the determination for a passenger, including sending a confirmation of the booking to a user device associated with the passenger.

2. The method of claim 1, further comprising generating a priority identifier associated with the booking confirmation and storing the priority identifier in the PSS.

3. The method of claim 1, wherein the priority disembarkment option includes an associated fee processed via an IATA New Distribution Capability (NDC) standard.

4. The method of claim 1, wherein the determining availability employs a priority queue data structure in a disembarkment data handling module to allocate slots in real-time while interfacing with the PSS via secure APIs.

5. A computer-implemented method for detecting a late flight arrival and organizing priority disembarkment for at-risk passengers, the method comprising:
receiving, by a computing system, a notice of a flight delay of an incoming flight;
obtaining a passenger identifier associated with at least one passenger having a
connecting flight in response to receiving the notice of the flight delay;
receiving, from an Airport Operational Database (AODB), connecting flight information, arriving gate information associated with the arriving flight, and connecting gate information associated with the connecting flight;
computing a gate-to-gate travel time to generate a time interval based on estimated passenger travel times from the arriving gate to the connecting gate;
determining whether the time interval is sufficient for the at least one passenger to reach the connecting flight gate prior to the closing of that gate for the connecting flight, wherein sufficiency is defined by airline business rules including a buffer time;
identifying the at least one passenger as at-risk when the time interval is determined to be insufficient without priority disembarkment but sufficient with priority disembarkment; and
organizing priority disembarkment for the at-risk passenger by associating the at-risk passenger with a priority disembarkment pass, the disembarkment pass comprising passenger details, aircraft details, and a priority disembarking status.

6. The method of claim 5, further comprising notifying the at-risk passenger of the priority disembarkment pass and presenting a waiver for acceptance prior to associating the at-risk passenger with the priority disembarkment pass.

7. The method of claim 5, further comprising deactivating the priority disembarkment pass after the at-risk passenger disembarks, using geo-fencing to detect departure from the aircraft.

8. The method of claim 5, wherein the priority disembarkment pass is physical or virtual and includes a readable medium for cabin staff verification.

9. The method of claim 5, wherein computing the gate-to-gate travel time employs a graph data structure representing airport layouts with nodes as gates and weighted edges based on real-time pedestrian traffic data.

10. The method of claim 5, further comprising recommending an alternative arriving gate by rank-ordering available gates based on aggregate travel times for multiple at-risk passengers.

11. A system for managing airline passenger disembarkment, comprising:
a processing unit;
a memory coupled to the processing unit; and
a disembarkment data handling module stored in the memory and executable by the processing unit, the disembarkment data handling module configured to:
receive flight information including booking requests and delay notices via integration with
a Passenger Service System (PSS) and an Airport Operational Database (AODB);
process the flight information to identify passengers requiring priority disembarkment using distributed software modules that interact with hardware components for real-time data exchange; and
assign priority disembarkment status to the identified passengers based on airline business rules, including generating a priority disembarkment pass with verification elements.

12. The system of claim 11, wherein processing the flight information includes reserving priority disembarkment by determining availability via the PSS and employing a priority queue data structure to allocate slots.

13. The system of claim 11, wherein processing the flight information includes detecting late arrival and organizing priority disembarkment by computing gate-to-gate travel times using a graph data structure and identifying at-risk passengers.

14. The system of claim 11, wherein the disembarkment data handling module is further configured to deactivate the priority disembarkment pass using geo-fencing or hash-based verification integrated with gate hardware.

15. The system of claim 11, wherein the verification elements of the priority disembarkment pass include at least one of a QR code, NFC unit, or RFID unit for secure, tamper-proof cabin staff verification.
